(19) United States
(12) Patent Application Publication
(10) Pub. No.: US 2024/0117176 A1
(43) Pub. Date: Apr. 11, 2024

(54) CHLORINATED POLYVINYL CHLORIDE RESIN COMPOSITION, EXTRUDED SHEET AND METHOD FOR MANUFACTURING THE SAME

(71) Applicant: NAN YA PLASTICS CORPORATION, Taipei (TW)

(72) Inventors: TE-CHAO LIAO, TAIPEI (TW); HAN-CHING HSU, TAIPEI (TW); CHUN-LAI CHEN, TAIPEI (TW); WEN-YI WU, TAIPEI (TW)

(21) Appl. No.: 18/079,968

(22) Filed: Dec. 13, 2022

(30) Foreign Application Priority Data
Oct. 7, 2022 (TW) 111138131

(51) Int. Cl. C08L 27/24; B29C 48/00; C08F 212/08; C08F 220/14; C08F 236/06; C08F 259/04; C08J 5/18; C08L 27/06

(52) U.S. Cl. CPC C08L 27/24; B29C 48/022; C08F 212/08; C08F 220/14; C08F 236/06; C08F 259/04; C08J 5/18; C08L 27/06; C08L 2205/025; C08L 2205/035

(57) ABSTRACT

A chlorinated polyvinyl chloride resin composition, an extruded sheet and a method for manufacturing the same are provided. The chlorinated polyvinyl chloride resin composition includes a chlorinated polyvinyl chloride resin and a plasticizing processing aid. The chlorinated polyvinyl chloride resin has an amount of 80 parts by weight to 120 parts by weight, a degree of polymerization of from 500 to 1,100, and a chlorine content of from 60% to 75%. The plasticizing processing aid includes a vinyl chloride graft copolymer and an acrylic compound. A grafted functional group of the vinyl chloride graft copolymer is at least one of polyol ester and ethylene vinyl acetate.

### CROSS-REFERENCE TO RELATED PATENT APPLICATION

This application claims the benefit of priority to Taiwan Patent Application No. 111138131, filed on Oct. 7, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a resin composition, and more particularly to a chlorinated polyvinyl chloride resin composition, an extruded sheet, and a method for manufacturing the same.

### BACKGROUND OF THE DISCLOSURE

Chlorinated polyvinyl chloride (CPVC) is a thermoplastic produced by chlorination of polyvinyl chloride resin. Chlorinated polyvinyl chloride has better heat resistance, corrosion resistance, and flame retardancy than common polyvinyl chloride. Furthermore, chlorinated polyvinyl chloride has high mechanical strength, flexibility, and insulation, and has the advantages of pollution-free, not easily aged, having lightweight, convenience in application, etc.

Transparent products made from polyvinyl chloride resin are widely used in the electrical, automotive, medical, and semiconductor industries. However, most of commercially available chlorinated polyvinyl chloride extruded sheets do not have transparency, or only have low transparency, so that they are subjected to many limitations in terms of applications. For example, they cannot be applied to devices that require transparency.

In China Patent Publication No. CN101421347B, a chlorinated polyvinyl chloride resin with heat resistance and optical transparency and a method for manufacturing the same are disclosed. In this patent, polyphenyl sulfone (PPSU) and polyethylene terephthalate (PET) are used as main materials, and by adding a coupling agent and an accelerant, the PPSU and the PET are cross-linked with each other, so that the resin composition that are prepared can achieve better mechanical strength and transparency.

Furthermore, in China Patent Publication No. CN105295271B, a chlorinated polyvinyl chloride resin composition with heat resistance and optical transparency is disclosed. In this patent, a plurality of auxiliaries are compounded with a chlorinated polyvinyl chloride resin, and the use of a perchlorate transparency modifier particularly changes the intrachain complexation and electron cloud distribution of chlorinated polyvinyl chloride, so that the prepared chlorinated polyvinyl chloride resin composition can have a light transmittance of over 80% and a Vicat softening temperature of over 110° C.

Moreover, in Patent Cooperation Treaty Patent Publication No. WO2007121046A1, a chlorinated polyvinyl chloride resin with heat resistance and optical transparency and a method for manufacturing the same are provided. In this patent, the CPVC powders of different brands are compared. Among them, the CPVC powder (HA-17F) of Sekisui America Coporation (SAC) has a transparency of 57.2% and a haze of 12.7%.

Although the above-mentioned patented technologies enable the chlorinated polyvinyl chloride resin to possess heat resistance and optical transparency, they all have the problems such as requiring complicated processes, and having poor formula stability and insufficient transparency.

### SUMMARY OF THE DISCLOSURE

In response to the above-referenced technical inadequacies, the present disclosure provides a chlorinated polyvinyl chloride resin composition, an extruded sheet and a method for manufacturing the same.

In one aspect, the present disclosure provides a chlorinated polyvinyl chloride resin composition. The chlorinated polyvinyl chloride resin composition includes a chlorinated polyvinyl chloride resin, in which the chlorinated polyvinyl chloride resin has an amount of 80 parts by weight to 120 parts by weight, a degree of polymerization of 400 to 1,100, and a chlorine content of 60 to 75%; and a plasticizing processing aid, in which the plasticizing processing aid includes a vinyl chloride graft copolymer and an acrylic compound, and a grafted functional group of the vinyl chloride graft copolymer is at least one material selected from a group consisting of polyol ester and ethylene vinyl acetate, in which an amount of the vinyl chloride graft copolymer is A parts by weight, an amount of the acrylic compound is B parts by weight, and an amount of the plasticizing processing aid meets the following conditions: (i) A+B is not greater than 5 parts by weight; (ii) A/(A+B) is not less than 80%; and (iii) B/(A+B) is not greater than 20%, wherein the chlorinated polyvinyl chloride resin composition has a plasticizing rate of 50 sec to 100 sec at a temperature of 170° C. to 200° C.

In certain embodiments, the chlorinated polyvinyl chloride resin composition further includes a transparent toughening agent, in which an amount of the transparent toughening agent ranges from 0.5 parts by weight to 20 parts by weight, and the transparent toughening agent is methyl methacrylate-butadiene-styrene elastomer.

In certain embodiments, the chlorinated polyvinyl chloride resin composition further comprises: a heat resistance improving agent, wherein an amount of the heat resistance improving agent ranges from 0.5 parts by weight to 30 parts by weight, and the heat resistance improving agent is an alpha-methyl styrene acrylonitrile copolymer and has a heat deflection temperature of 115° C. to 130° C.

In certain embodiments, the chlorinated polyvinyl chloride resin composition further comprises: a heat stabilizer, wherein an amount of the heat stabilizer ranges from 0.5 parts by weight to 10 parts by weight, and the heat stabilizer is at least one material selected from a group consisting of organotin thioesters, calcium/zinc stabilizer and talc stabilizer.

In certain embodiments, the chlorinated polyvinyl chloride resin composition further comprises: an auxiliary heat stabilizer, wherein an amount of the auxiliary heat stabilizer ranges from 0.1 parts by weight to 3 parts by weight, and the auxiliary heat stabilizer is epoxidized soybean oil.

In certain embodiments, the chlorinated polyvinyl chloride resin composition further comprises: a lubricant, wherein an amount of the lubricant ranges from 0.1 parts by weight to 1 part by weight, and the lubricant is at least one material selected from a group consisting of montan wax, complex ester wax, polyethylene wax and oxidized polyethylene wax.

In certain embodiments, the chlorinated polyvinyl chloride resin composition further comprises: an antioxidant, wherein an amount of the antioxidant ranges from 0.1 parts by weight to 3 parts by weight, and the antioxidant is at least one material selected from a group consisting of hindered phenolic antioxidant and phosphite antioxidant.

In certain embodiments, the chlorinated polyvinyl chloride resin composition further comprises: a pigment, wherein an amount of the pigment ranges from 0.0001 parts by weight to 0.05 parts by weight, and the pigment is at least one material selected from a group consisting of ultramarine pigment and violet pigment.

In another aspect, the present disclosure provides an extruded sheet formed from the abovementioned chlorinated polyvinyl chloride resin composition.

In yet another aspect, the present disclosure provides a method for manufacturing an extruded sheet, comprising: adding the chlorinated polyvinyl chloride resin composition into a hot mixer; mixing the vinyl chloride resin composition at a stirring speed between 300 RPM and 1,800 RPM and a heating temperature between 100° C. and 120° C.; putting the mixed vinyl chloride resin composition into a cold mixer, in which the temperature is lowered to a cooling temperature between 35° C. and 50° C.; and putting the cooled vinyl chloride resin composition into an extruder, in which melt-mixing is performed at a melting temperature between 170° C. and 200° C., and then extrusion, molding, cooling and trimming are performed sequentially to obtain an extruded sheet.

One of the beneficial effects of the present disclosure is that, in the chlorinated polyvinyl chloride resin composition, the extruded sheet and the method for manufacturing the same provided by the present disclosure, by virtue of “providing a chlorinated polyvinyl chloride resin, in which an amount of the chlorinated polyvinyl chloride resin being from 80 parts by weight to 120 parts by weight, and the chlorinated polyvinyl chloride resin having a degree of polymerization of from 400 to 1,100, and a chlorine content of from 60% to 75%,” “a plasticizing processing aid including a vinyl chloride graft copolymer and an acrylic compound, and a grafted functional group of the vinyl chloride graft copolymer being at least one material selected from a group consisting of polyol ester and ethylene vinyl acetate,” and “an amount of the vinyl chloride graft copolymer being A parts by weight, an amount of the acrylic compound being B parts by weight, and an amount of the plasticizing processing aid meeting the following conditions: (i) A+B is not greater than 5 parts by weight; (ii) A/(A+B) is not less than 80%; and (iii) B/(A+B) is not greater than 20%; and the chlorinated polyvinyl chloride resin composition having a plasticizing rate of from 50 sec to 100 sec at a temperature of from 170° C. to 200° C.,” the CPVC extruded sheet can possess high heat resistance, high toughness, high transparency, low haze, and excellent formability. Furthermore, the CPVC extruded sheet has the advantages of being easily manufactured and having good formula stability.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing an extruded sheet according to one embodiment of the present disclosure.

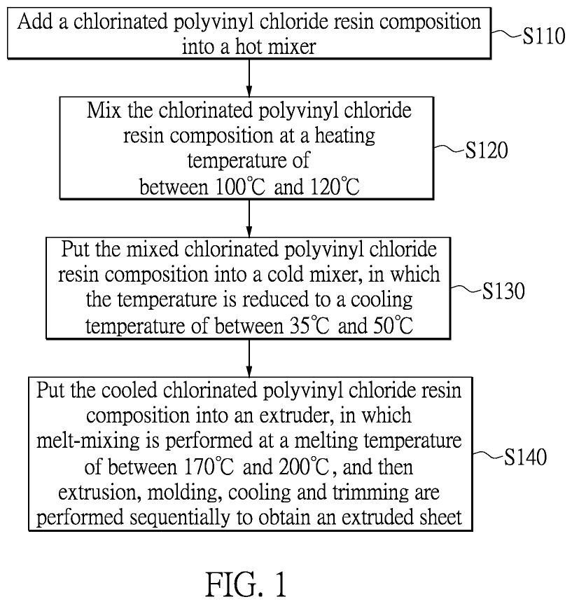

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Chlorinated Polyvinyl Chloride Resin Composition

Embodiments of the present disclosure provide a chlorinated polyvinyl chloride resin composition suitable for forming an extruded sheet through an extrusion process, and the chlorinated polyvinyl chloride resin composition has high transparency and heat resistance.

In order to achieve the abovementioned purposes, the chlorinated polyvinyl chloride resin composition of the embodiment of the present disclosure includes at least a chlorinated polyvinyl chloride (CPVC) resin and a plasticizing processing aid.

An amount of the chlorinated polyvinyl chloride resin is between 80 parts by weight and 120 parts by weight, and preferably between 90 parts by weight and 110 parts by weight. A degree of polymerization (DP) of the chlorinated polyvinyl chloride resin is between 400 and 1,100, and preferably between 500 and 1,000. A chlorine content of the chlorinated polyvinyl chloride resin is between 60% and 75%, and preferably between 65% and 70%. It should be noted that, the “degree of polymerization” mentioned in the present disclosure is an index for measuring the molecular size of a polymer. Based on the number of repeating units, an average number of the repeating units contained in the macromolecular chain of the polymer can be referred to as an average degree of polymerization. In addition, the “chlorine content” mentioned in the present disclosure is in wt %, and can be measured by a manner as described in JIS K 7229.

The plasticizing processing aid includes a vinyl chloride graft copolymer and an acrylic (ACR) compound that is optionally added.

A grafted functional group of the vinyl chloride graft copolymer is at least one material selected from a group consisting of polyol ester and ethylene vinyl acetate. An amount of the vinyl chloride graft copolymer is A parts by weight, and an amount of the acrylic compound is B parts by weight.

In this embodiment, an amount of the plasticizing processing aid meets the following conditions:
(i) A+B is not greater than 5 parts by weight, preferably between 0.5 parts by weight and 5 parts by weight, and particularly preferably between 0.5 parts by weight and 4.5 parts by weight.
(ii) A/(A+B) is not less than 80%, and preferably not less than 85%.
(iii) B/(A+B) is not greater than 20%, and preferably not greater than 15%.

Furthermore, the chlorinated polyvinyl chloride resin composition of the embodiments of the present disclosure has a plasticizing rate of 50 sec to 100 sec, and preferably 60 sec to 80 sec at a temperature of from 170° C. to 200° C.

It should be noted that, the patents involving compositions usually adopt two manners of expression, namely, “parts by weight” and “weight percentage (wt %)”. A “parts notation” for a composition reflects a proportional relationship between components, and does not need to meet the limitations on two “formulas of requirements for upper and lower limits and a total percentage being 100 in an embodiment” as in a “percentage notation”. The two “formulas of requirements for upper and lower limits” are: an upper limit of the content of a single component plus a lower limit of the content of the remaining components being <=100%; and a lower limit of the content of a single component plus an upper limit of the content of the remaining components being >=100%. If the parts by weight is converted to a percentage, it implies a percentage basis, namely a total amount basis, and then the rules of the upper and lower limits must be followed. An example of conversion mode are as follows: A composition includes 50 parts by weight of A and 20 parts by weight of B, or after conversion, includes 50/(50+20) wt % of A and 20/(50+20) wt % of B.

Accordingly, the chlorinated polyvinyl chloride resin composition of the embodiments of the present disclosure uses a vinyl chloride graft copolymer as a main plasticizing processing aid, and the vinyl chloride graft copolymer has good compatibility with the chlorinated polyvinyl chloride resin and can provide good low-temperature plasticizing ability. The vinyl chloride graft copolymer can replace or effectively reduce the amount of a conventional plasticizing processing aid (e.g., ACR). In addition, the chlorinated polyvinyl chloride resin composition of the embodiment of the present disclosure can realize low-temperature fast plasticization without adding a plasticizer, and can suppress the issues of pyrolysis and yellowing of the chlorinated polyvinyl chloride resin at a high temperature, thereby increasing the transparency, improving the hue, and reducing the haze of the material.

More specifically, the vinyl chloride graft copolymer has good compatibility with the chlorinated polyvinyl chloride resin (CPCV) by having a chemical structure of vinyl chloride, and provides good low-temperature plasticizing ability by having a grafted functional group (e.g., polyol ester or ethylene vinyl acetate). It should be noted that, in terms of plasticizing ability, the grafted functional group needs to be selected from polyol ester or ethylene vinyl acetate in order to provide good low-temperature plasticizing ability. If other types of functional groups are grafted, the vinyl chloride graft copolymer may fail to provide good low-temperature plasticizing ability, and the technical purposes of the present disclosure cannot be achieved, e.g., the transparency cannot be improved. That is to say, the grafted functional group of the vinyl chloride graft copolymer in the embodiments of the present disclosure is selected through specific considerations.

Furthermore, the chlorinated polyvinyl chloride resin composition of the embodiment of the present disclosure can produce an effect of an external lubricant by using the vinyl chloride graft copolymer, thereby reducing the amount of the external lubricant used and achieving the purposes of improving the transparency, reducing the haze, and realizing excellent formability.

In certain embodiments of the present disclosure, in order to improve the compatibility of the vinyl chloride graft copolymer with the chlorinated polyvinyl chloride resin and provide a good low-temperature plasticizing rate, the vinyl chloride graft copolymer has a vinyl chloride content of from 65 wt % to 85 wt %, a grafting rate of vinyl functional group of from 10 wt % to 15 wt %, and a grafting rate of polyol ester functional group of from 5 wt % to 15 wt %, but the present disclosure is not limited thereto.

In certain embodiments of the present disclosure, the chlorinated polyvinyl chloride resin composition may further include a transparent toughening agent.

An amount of the transparent toughening agent is between 0.5 parts by weight and 20 parts by weight, and preferably between 1 part by weight and 10 parts by weight.

The transparent toughening agent may be, for example, Methyl methacrylate-Butadiene-Styrene (MBS) elastomer, but the present disclosure is not limited thereto.

Thanks to the good compatibility of the vinyl chloride graft copolymer with the chlorinated polyvinyl chloride resin and the transparent toughening agent, the embodiments of the present disclosure provide good synergistic impact resistance, and can effectively reduce the addition amount of an anti-impact agent while maintaining the impact resistance, increasing the heat deflection temperature, and reducing the cost.

In certain embodiments of the present disclosure, the chlorinated polyvinyl chloride resin composition may further include a heat resistance improving agent.

An amount of the heat resistance improving agent is between 0.5 parts by weight and 30 parts by weight, and preferably between 1 part by weight and 20 parts by weight.

The heat resistance improving agent may be, for example, an alpha-methyl styrene acrylonitrile copolymer, but the present disclosure is not limited thereto.

The alpha-methyl styrene acrylonitrile copolymer used in the embodiments of the present disclosure has a heat deflection temperature of from 115° C. to 130° C., and preferably from 120° C. to 125° C. Furthermore, the alpha-methyl styrene acrylonitrile copolymer has good compatibility with the chlorinated polyvinyl chloride resin, such that the extruded sheet has high transparency and high heat deflection temperature.

In certain embodiments of the present disclosure, the chlorinated polyvinyl chloride resin composition may further include a heat stabilizer.

An amount of the heat stabilizer is between 0.5 parts by weight and 10 parts by weight, and preferably between 1 part by weight and 5 parts by weight.

The heat stabilizer is at least one material selected from a group consisting of organotin thioesters, calcium/zinc stabilizer, and talc stabilizer. The organotin thioesters may be, for example, methyl tin mercaptide, but the present disclosure is not limited thereto.

In certain embodiments of the present disclosure, the chlorinated polyvinyl chloride resin composition may further include an auxiliary heat stabilizer.

An amount of the auxiliary heat stabilizer is between 0.1 parts by weight and 3 parts by weight, and preferably between 0.1 parts by weight and 1 part by weight.

The auxiliary heat stabilizer may be, for example, epoxidized soybean oil (ESO), but the present disclosure is not limited thereto.

In certain embodiments of the present disclosure, the chlorinated polyvinyl chloride resin composition may further include a lubricant.

An amount of the lubricant is between 0.1 parts by weight and 1 part by weight, and preferably between 0.1 parts by weight and 0.5 parts by weight.

The lubricant is at least one material selected from a group consisting of montan wax, complex ester wax, polyethylene wax, and oxidized polyethylene wax, but the present disclosure is not limited thereto.

It should be noted that, the above-mentioned lubricants all belong to organic wax and can provide lubricity while maintaining transparency.

In certain embodiments of the present disclosure, the chlorinated polyvinyl chloride resin composition may further include an antioxidant.

An amount of the antioxidant is between 0.1 parts by weight and 3 parts by weight, and preferably between 0.1 parts by weight and 1 part by weight.

The antioxidant is at least one material selected from a group consisting of hindered phenolic antioxidant and phosphite antioxidant, but the present disclosure is not limited thereto. A specific embodiment of the present disclosure uses a hindered phenolic antioxidant that is known as I-1010.

In certain embodiments of the present disclosure, the chlorinated polyvinyl chloride resin composition may further include a pigment.

An amount of the pigment is between 0.0001 parts by weight and 0.05 parts by weight, and preferably between 0.0001 parts by weight and 0.01 parts by weight.

The pigment is at least one material selected from a group consisting of ultramarine pigment and violet pigment.

### Method for Manufacturing Extruded Sheet

The abovementioned embodiments are descriptions of the material characteristics of the vinyl chloride resin composition, and the following is a description of a method for manufacturing an extruded sheet according to one embodiment of the present disclosure.

One embodiment of the present disclosure provides the method for manufacturing an extruded sheet. The method for manufacturing an extruded sheet includes Step S110, Step S120, Step S130, and Step S140.

The Step S110 includes: adding the vinyl chloride resin composition of the abovementioned embodiment into a hot mixer according to the aforementioned proportions.

The Step S120 includes: mixing the vinyl chloride resin composition in the hot mixer at a stirring speed of between 300 RPM and 1,800 RPM and a heating temperature of between 100° C. and 120° C.

The Step S130 includes: putting the mixed vinyl chloride resin composition into a cold mixer, in which the temperature of the mixed vinyl chloride resin composition is lowered to a cooling temperature of between 35° C. and 50° C.

The Step S140 includes: putting the cooled vinyl chloride resin composition into an extruder, in which melt-mixing is performed at a melting temperature of between 170° C. and 200° C., and then extrusion, molding, cooling and trimming are performed sequentially to obtain a CPVC extruded sheet.

According to the abovementioned configuration, the CPVC extruded sheet can have high heat resistance, high toughness, high transparency, low haze, and excellent formability. Moreover, the CPVC extruded sheet has the advantages of being easily manufactured and having good formula stability.

### Experimental Data and Test Results

Hereinafter, the contents of the present disclosure are described in detail with reference to Examples 1 to 4 and Comparative Examples 1 to 2. However, the following examples are provided only to assist in the understanding of the present disclosure, and the scope of the present disclosure is not limited to the following examples.

Example 1: Chlorinated polyvinyl chloride, a heat stabilizer, and an auxiliary heat stabilizer are added according to the proportions in Example 1 under a low-speed stirring, and mixed at a heating temperature of 110° C.; under an increased stirring speed, vinyl/vinyl acetate, MBS, an alpha heat resistance improving agent, an antioxidant, and a pigment are sequentially added, stirred uniformly, and then discharged into a cold mixer, and the temperature of the mixture is lowered to from 35° C. to 50° C.; the vinyl chloride resin composition of Example 1 is then put into an extruder and melt-mixed at a melting temperature of from 170° C. to 200° C.; and then extrusion, molding, cooling and trimming are sequentially performed to obtain a CPVC extruded sheet.

Example 2: Chlorinated polyvinyl chloride, a heat stabilizer, and an auxiliary heat stabilizer are added according to the proportions in Example 2 under a low-speed stirring, and mixed at a heating temperature of 110° C.; under an increased stirring speed, vinyl/vinyl acetate, MBS, an alpha heat resistance improving agent, a lubricant, an antioxidant and a pigment are sequentially added, stirred uniformly, and then discharged into a cold mixer, and the temperature of the mixture is lowered to be 40° C.; the vinyl chloride resin composition of Example 2 is then put into an extruder and melt-mixed at a melting temperature of from 170° C. to 200° C.; and then extrusion, molding, cooling and trimming are sequentially performed to obtain a CPVC extruded sheet.

Example 3: Chlorinated polyvinyl chloride, a heat stabilizer, and an auxiliary heat stabilizer are added according to the proportions in Example 3 under a low-speed stirring, and mixed at a heating temperature of 110° C.; under an increased stirring speed, vinylidene chloride/vinyl versatate, MBS, an alpha heat resistance improving agent, an antioxidant, and a pigment are sequentially added, stirred uniformly and then discharged into a cold mixer, and the temperature of the mixture is lowered to from 35° C. to 50° C.; the vinyl chloride resin composition of Example 3 is then put into an extruder and melt-mixed at a melting temperature of from 170° C. to 200° C.; and then extrusion, molding, cooling and trimming are sequentially performed to obtain a CPVC extruded sheet.

Example 4: Chlorinated polyvinyl chloride, a heat stabilizer, and an auxiliary heat stabilizer are added according to the proportions in Example 4 under a low-speed stirring, and mixed at a heating temperature of 110° C.; under an increased stirring speed, vinylidene chloride/vinyl versatate, MBS, an alpha heat resistance improving agent, a lubricant, an antioxidant, and a pigment are sequentially added, stirred uniformly, and then discharged into a cold mixer, and the temperature of the mixture is lowered to from 35° C. to 50° C.; the vinyl chloride resin composition of Example 4 is then put into an extruder and melt-mixed at a melting temperature of from 170° C. to 200° C.; and then extrusion, molding, cooling and trimming are sequentially performed to obtain a CPVC extruded sheet.

Comparative Example 1: Chlorinated polyvinyl chloride, a heat stabilizer, and an auxiliary heat stabilizer are added according to the proportions in Comparative Example 1 under a low-speed stirring, and mixed at a heating temperature of 110° C.; under an increased stirring speed, MBS, a lubricant, an antioxidant, and a pigment are sequentially added, stirred uniformly, and then discharged into a cold mixer, and the temperature of the mixture is lowered to from 35° C. to 50° C.; the vinyl chloride resin composition of Comparative Example 1 is then put into an extruder and melt-mixed at a melting temperature of from 170° C. to 200° C.; and then extrusion, molding, cooling and trimming are sequentially performed to obtain a CPVC extruded sheet.

Comparative Example 2: Chlorinated polyvinyl chloride, a heat stabilizer, and an auxiliary heat stabilizer are added according to the proportions in Comparative Example 2 under a low-speed stirring, and mixed at a heating temperature of 110° C.; under an increased stirring speed, an acrylic processing aid, MBS, an alpha heat resistance improving agent, a lubricant, an antioxidant, and a pigment are sequentially added, stirred uniformly, and then discharged into a cold mixer, and the temperature of the mixture is lowered to from 35° C. to 50° C.; the vinyl chloride resin composition of Comparative Example 2 is then put into an extruder and melt-mixed at a melting temperature of from 170° C. to 200° C.; and then extrusion, molding, cooling and trimming are sequentially performed to obtain a CPVC extruded sheet.

The manufacturing process parameters and conditions of the components are listed in Table 1 below.

Then, the chlorinated polyvinyl chloride extruded sheets manufactured in Examples 1 to 4 and Comparative Examples 1 to 2 are tested for physical and chemical properties to obtain the physical and chemical properties of the polyvinyl chloride extruded sheets, such as heat-resistance temperature (° C.), toughness (Kgf-cm/cm²), transparency (%), haze (%), and plasticizing rate. Relevant test manners are as described below, and the results of relevant tests are listed in Table 1.

Heat-resistance temperature:From comparison between Examples 1 to 4 and Comparative Example 1, the formula having the heat resistance improving agent added therein can effectively increase the Vicat softening temperature to 109° C. The heat-resistance temperature is tested with a heat deflection Vicat softening temperature (VST) tester, and the VST is determined according to “GB/T 1633: Plastics-Thermoplastic Materials-Determination of Vicat Softening Temperature (VST)”, and “GB 8802: Method for the Determination of Vicat Softening Temperature of Unplasticised Polyvinyl Chloride (PVC-U) Pipes and Fittings,” and ASTM 1525.

Toughness: From comparison between Examples 1 to 4 and Comparative Example 2, the toughness can be slightly improved to 3.3 Kgf-cm/cm2 by partially replacing the acrylic processing aid with the vinyl chloride graft copolymer. The toughness is obtained by testing the notched bending impact strength (IZOD) of a test piece using an impact strength tester according to ASTM D256.

Transparency: From comparison between Examples 1 and 3 and Comparative Example 1, adding excessive lubricant will reduce the transparency. From comparison between Examples 1 and 3 and Comparative Example 2, adding the polyvinyl chloride graft copolymer can effectively increase the transparency. The transparency is obtained by testing a total light transmittance (T.T) using a haze tester conforming to ASTM D1003 and ISO 13468, where the total light transmittance (T.T) of a sheet is taken as representing transparency.

Haze: From comparison between Examples 1 and 3 and Comparative Example 1, adding excessive lubricant will significantly increase the haze. The haze is obtained by testing a haze value HAZE (a ratio of a diffusion transmittance to a total light transmittance (T.T)) using a haze tester conforming to ASTM D1003 and ISO 14782.

Plasticizing rate: From comparison between Examples 1 and 3 and Comparative Example 2, adding the polyvinyl graft copolymer leads to a similar plasticizing rate to adding the acrylic processing aid; and from comparison between Examples 1 and 3 and Comparative Example 1, adding the polyvinyl graft copolymer increases the plasticizing rate relative to not adding the acrylic processing aid, and is conducive to improving the transparency and increasing the production speed. The plasticizing rate is obtained by performing a rheological test using a torque rheometer (e.g., HAAKE PolyLab OS) at a specific temperature (from 170° C. to 200° C.) and a specific rotation speed (from 45 to 60 RPM), in which a plasticizing time and a balancing torque of the formula under detection are taken as a basis for assessing productivity of the formula.

TABLE 1
[Experimental Conditions and Test Results]

| | | | | | | Comparative | Comparative |
|---|---|---|---|---|---|---|---|
| Item | | Example 1 | Example 2 | Example 3 | Example 4 | example 1 | example 2 |
| Chlorinated | Chlorinated | 100 | 100 | 100 | 100 | 100 | 100 |
| polyvinyl | polyvinyl | | | | | | |
| chloride | chloride resin | | | | | | |
| resin | (parts by weight) | | | | | | |
| composition | Vinyl | 2 | 4 | 2 | 4 | — | — |
| | chloride graft | | | | | | |
| | copolymer | | | | | | |
| | (parts by weight) | | | | | | |
| | Grafted | Vinyl/vinyl | Vinyl/vinyl | Vinylidene | Vinylidene | — | — |
| | functional group | acetate | acetate | chloride/vinyl | chloride/vinyl | | |
| | | | | versatate | versatate | | |
| | Acrylic compound | 0 | 0.5 | 0 | 0.5 | 0 | 2 |
| | (parts by weight) | | | | | | |
| | Transparent | 4 | 4 | 4 | 4 | 6 | 6 |
| | toughening agent | | | | | | |
| | (parts by weight) | | | | | | |
| | Material type | MBS | MBS | MBS | MBS | MBS | MBS |
| | of transparent | | | | | | |
| | toughening agent | | | | | | |
| | Heat resistance | 10 | 10 | 10 | 10 | 0 | 10 |
| | improving agent | | | | | | |
| | (parts by weight) | | | | | | |
| | Material | Material of | Material of | Material of | Material of | — | Material of |
| | type of heat | alpha heat | alpha heat | alpha heat | alpha heat | | alpha heat |
| | resistance | resistance | resistance | resistance | resistance | | resistance |
| | improving | improving | improving | improving | improving | | improving |
| | agent | agent | agent | agent | agent | | agent |
| | Heat stabilizer | 2.5 | 2.5 | 2.5 | 2.5 | 2.5 | 2.5 |
| | (parts by weight) | | | | | | |
| | Material | Methyl tin | Methyl tin | Methyl tin | Methyl tin | Methyl tin | Methyl tin |
| | type of heat | mercaptide | mercaptide | mercaptide | mercaptide | mercaptide | mercaptide |
| | stabilizer | | | | | | |
| | Auxiliary heat | 0.5 | 0.5 | 0.5 | 0.5 | 0.5 | 0.5 |
| | stabilizer | | | | | | |
| | (parts by weight) | | | | | | |
| | Material type | Epoxidized | Epoxidized | Epoxidized | Epoxidized | Epoxidized | Epoxidized |
| | of auxiliary | soybean | soybean | soybean | soybean | soybean | soybean |
| | heat stabilizer | oil | oil | oil | oil | oil | oil |
| | Lubricant | 0.1 | 0.5 | 0.1 | 0.5 | 0.5 | 0.1 |
| | (parts by weight) | | | | | | |
| | Material type | — | OPE wax | — | OPE wax | OPE wax | — |
| | of lubricant | | | | | | |
| | Antioxidant | 0.5 | 0.5 | 0.5 | 0.5 | 0.5 | 0.5 |
| | (parts by weight) | | | | | | |
| | Material type | I-1010 | I-1010 | I-1010 | I-1010 | I-1010 | I-1010 |
| | of antioxidant | | | | | | |
| | Pigment | 0.0005 | 0.0005 | 0.0005 | 0.0005 | 0.0005 | 0.0005 |
| | (parts by weight) | | | | | | |
| | Material type | Ultra- | Ultra- | Ultra- | Ultra- | Ultra- | Ultra- |
| | of pigment | marine | marine | marine | marine | marine | marine |
| Physical | Vicat softening | 108.7 | 108.1 | 109.4 | 108.6 | 94.6 | 107.7 |
| and | temperature (° C.) | | | | | | |
| chemical | Impact strength | 3.3 | 3.2 | 3.1 | 3.0 | 2.4 | 2.8 |
| properties | (Kgf-cm/cm²) | | | | | | |
| | Transparency (%) | 81.3 | 72.3 | 81.4 | 71.8 | 65.8 | 73.5 |
| | Haze | 7.8 | 17.5 | 7.7 | 17.9 | 19.4 | 8.6 |
| | Plasticizing | 68 | 92 | 73 | 97 | 158 | 75 |
| | rate (sec) | | | | | | |
| | Balancing | 27.4 | 26.9 | 27.9 | 27.2 | 32.5 | 28.3 |
| | torque (N · m) | | | | | | |
| | Processability | Good | Good | Good | Good | Poor | Poor |

### Discussion on Test Results

In Examples 1 to 4, adding the vinyl chloride graft copolymer instead of the conventional acrylic processing aid can maintain the plasticizing rate, and can also have the effects of improving toughness, increasing transparency, reducing haze, reducing processing torque, reducing equipment load, improving processability, etc. Adding the heat resistance improving agent can maintain high transparency and significantly increase the Vicat softening temperature of the sheet.

It should be noted that, in Examples 1 to 4, some auxiliary additives (e.g., toughening agent, heat resistance improving agent, heat stabilizer, auxiliary heat stabilizer, lubricant, antioxidant, and pigment) are each exemplified using only one material type and amount. However, Examples 1 to 4 are intended to prove the technical effect of “adding the vinyl chloride graft copolymer instead of the conventional acrylic processing aid,” which is clearly proven. The experimental data in Table 1 do not put emphasis on the material types or amounts of the auxiliary additives. Therefore, the material types or amounts of for the auxiliary additives in Examples 1 to 4 are only intended for exemplification and assist in the understanding of the present disclosure, and the scope of protection of the present disclosure is not limited to the contents described in the abovementioned examples.

### Beneficial Effects of the Embodiments

One of the beneficial effects of the present disclosure is that, in the chlorinated polyvinyl chloride resin composition, the extruded sheet and the method for manufacturing the same provided by the present disclosure, by virtue of “providing a chlorinated polyvinyl chloride resin, in which an amount of the chlorinated polyvinyl chloride resin being from 80 parts by weight to 120 parts by weight, and the chlorinated polyvinyl chloride resin having a degree of polymerization of from 400 to 1,100, and a chlorine content of from 60% to 75%,” “a plasticizing processing aid including a vinyl chloride graft copolymer and an acrylic compound, and a grafted functional group of the vinyl chloride graft copolymer being at least one material selected from a group consisting of polyol ester and ethylene vinyl acetate,” and “an amount of the vinyl chloride graft copolymer being A parts by weight, an amount of the acrylic compound being B parts by weight, and an amount of the plasticizing processing aid meeting the following conditions: (i) A+B is not greater than 5 parts by weight; (ii) A/(A+B) is not less than 80%; and (iii) B/(A+B) is not greater than 20%; and the chlorinated polyvinyl chloride resin composition having a plasticizing rate of from 50 sec to 100 sec at a temperature of from 170° C. to 200° C.,” the CPVC extruded sheet can possess high heat resistance, high toughness, high transparency, low haze, and excellent formability. Furthermore, the CPVC extruded sheet has the advantages of being easily manufactured and having good formula stability.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A chlorinated polyvinyl chloride resin composition, comprising:
a chlorinated polyvinyl chloride resin, wherein an amount of the chlorinated polyvinyl chloride resin is from 80 parts by weight to 120 parts by weight, and the chlorinated polyvinyl chloride resin has a degree of polymerization of from 400 to 1,100, and a chlorine content of from 60% to 75%; and
a plasticizing processing aid including a vinyl chloride graft copolymer and an acrylic compound, wherein a grafted functional group of the vinyl chloride graft copolymer is at least one material selected from a group consisting of polyol ester and ethylene vinyl acetate,
wherein an amount of the vinyl chloride graft copolymer is A parts by weight, an amount of the acrylic compound is B parts by weight, and an amount of the plasticizing processing aid meets the following conditions: (i) A+B is not greater than 5 parts by weight; (ii) A/(A+B) is not less than 80%; and (iii) B/(A+B) is not greater than 20%; and
wherein the chlorinated polyvinyl chloride resin composition has a plasticizing rate of from 50 sec to 100 sec at a temperature of from 170° C. to 200° C.

2. The chlorinated polyvinyl chloride resin composition of claim 1, further comprising: a transparent toughening agent, wherein an amount of the transparent toughening agent ranges from 0.5 parts by weight to 20 parts by weight, and the transparent toughening agent is a methyl methacrylate-butadiene-styrene elastomer.

3. The chlorinated polyvinyl chloride resin composition of claim 1, further comprising a heat resistance improving agent, wherein an amount of the heat resistance improving agent ranges from 0.5 parts by weight to 30 parts by weight, and the heat resistance improving agent is an alpha-methyl styrene acrylonitrile copolymer and has a heat deflection temperature of from 115° C. to 130° C.

4. The chlorinated polyvinyl chloride resin composition of claim 1, further comprising a heat stabilizer, wherein an amount of the heat stabilizer ranges from 0.5 parts by weight to 10 parts by weight, and the heat stabilizer is at least one material selected from a group consisting of organotin thioesters, calcium/zinc stabilizer, and talc stabilizer.

5. The chlorinated polyvinyl chloride resin composition of claim 1, further comprising an auxiliary heat stabilizer, wherein an amount of the auxiliary heat stabilizer ranges from 0.1 parts by weight to 3 parts by weight, and the auxiliary heat stabilizer is epoxidized soybean oil.

6. The chlorinated polyvinyl chloride resin composition of claim 1, further comprising a lubricant, wherein an amount of the lubricant ranges from 0.1 parts by weight to 1 part by weight, and the lubricant is at least one material selected from a group consisting of montan wax, complex ester wax, polyethylene wax, and oxidized polyethylene wax.

7. The chlorinated polyvinyl chloride resin composition of claim 1, further comprising an antioxidant, wherein an amount of the antioxidant ranges from 0.1 parts by weight to 3 parts by weight, and the antioxidant is at least one material selected from a group consisting of hindered phenolic antioxidant and phosphite antioxidant.

8. The chlorinated polyvinyl chloride resin composition of claim 1, further comprising a pigment, wherein an amount of the pigment ranges from 0.0001 parts by weight to 0.05 parts by weight, and the pigment is at least one material selected from a group consisting of ultramarine pigment and violet pigment.

9. An extruded sheet, formed from the chlorinated polyvinyl chloride resin composition according to claim 1.

10. A method for manufacturing an extruded sheet, comprising:
adding the chlorinated polyvinyl chloride resin composition according to claim 1 into a hot mixer;
mixing the vinyl chloride resin composition at a stirring speed of between 300 RPM and 1,800 RPM and a heating temperature of between 100° C. and 120° C.;
putting the vinyl chloride resin composition that is mixed into a cold mixer, wherein a temperature of the vinyl chloride resin composition that is mixed is lowered to a cooling temperature of between 35° C. and 50° C.; and
putting the vinyl chloride resin composition that is cooled into an extruder, wherein melt-mixing is performed at a melting temperature of between 170° C. and 200° C., and then extrusion, molding, cooling and trimming are performed sequentially to obtain an extruded sheet.
